(19) United States
(12) Patent Application Publication
(10) Pub. No.: US 2006/0161850 A1
(43) Pub. Date: Jul. 20, 2006

(54) Mass personalization of messages to enhance impact

(76) Inventor: John Seaberg, Eden Prairie, MN (US)

Correspondence Address: OPPENHEIMER WOLFF & DONNELLY LLP, 45 SOUTH SEVENTH STREET, SUITE 3300, MINNEAPOLIS, MN, 55402, US

(21) Appl. No.: 11/302,300

(22) Filed: Dec. 13, 2005

Related U.S. Application Data
(60) Provisional application No. 60/636,408, filed on Dec. 14, 2004.

(51) Int. Cl. G06F 3/00; G06F 17/00; G06F 17/21

(52) U.S. Cl. 715/744; 707/104.1; 715/500.1; 715/730

(57) ABSTRACT

A message program for managing mood or motivation may have greater impact on a user if it is personalization. To create such a personalized message, a system may first receive user information. In one embodiment, a template file is then selected. The personalized media program file is created using the template file and data from or based on the user information. For example, the user's name may be inserted in several locations, as indicated by the template file. In some embodiments, the personalized media program is based on a chosen theme. The personalized media program is then delivered to the user. The user information may include a goal desired by the user. This goal may be received by the user or by a medical professional having a relationship with the user.

### RELATED APPLICATIONS

This application claims the benefit of U.S. Provisional Application No. 60/636,408, filed 14 Dec. 2004, entitled “PERSONALIZATION OF MASS MESSAGES TO ENHANCE IMPACT,” which is incorporated herein by reference.

### FIELD OF THE INVENTION

This invention creates and deploys personalized media services, including audio narratives and text-to-speech programs, for the purpose of managing mood or motivation and increasing receptiveness to educational content.

### BACKGROUND OF THE INVENTION

Various methods have been employed to alter or reinforce a desired personal state. States have been limited to such concepts as mood and alertness and rarely advance to self-controlling behavior or receptiveness.

Examples of prior-art systems come from the fields of exercise, learning and games. In exercise applications guidance and motivation are provided when a ‘trainer’ records single, short messages of encouragement or specific instruction. The message could sometimes be manually or automatically replaced with a new message in concert with a programmed exercise regimen or change in exercise device. Student lessons have been customized by interactive testing and response to progression through teaching sets. In gaming the difficulty level, scene and interaction with other players can be changed with certain conditions.

In all of these prior art systems the form of customization was generally not defined by the customer (student, athlete, etc). Additionally, the customization was not applied to a customer's choice of programming or media. These and other drawbacks exist with all current customization systems. The present invention overcomes such drawbacks to create a system and method of mass personalization that gives greater control to a customer and makes the presented media specifically “personal” to the customer.

### SUMMARY OF THE INVENTION

A message program for managing mood or motivation may have greater impact on a user if it is personalized. To create such a personalized message, a system may first receive user information. In one embodiment, a template file is then selected. The personalized media program file is created using the template file and data from or based on the user information. For example, the user's name may be inserted in several locations, as indicated by the template file. In some embodiments, the personalized media program is based on a chosen theme. The personalized media program is then delivered to the user. The user information may include a goal desired by the user. This goal may be received by the user or by a medical professional having a relationship with the user.

### BRIEF DESCRIPTION OF THE DRAWINGS

FIG. 1 is flowchart for one embodiment of the invention delivered personalization services through a web site.

FIG. 2 is a block diagram illustrating an exemplary personal profile questionnaire.

### DETAILED DESCRIPTION OF THE PREFERRED EMBODIMENTS

The present invention creates and deploys personalized media. In one embodiment, a customer orders the creation of a custom media presentation based on preferences that are applied to an existing template or that originates from the customer input. The service may also alter and present information personalized from a customer's personal library, an on-line media service and other data repositories. The alterations may be pre-defined by a customer or by the customer's agent (e.g. a spouse seeking a gift, or a trainer or a medical professional engaged by the customer), or may also be dynamic and interactive, depending on the capabilities of storage, processing and presentation devices available at the time of presentation. In one example, the customer is referred to a website with the desire to quit smoking. They choose one of the smoking cessation scripts and options, such as the male or female reader and provide their name to complete the order. Through the internet the recording is delivered to their media storage device, such as an iPod player.

The invention has several exemplary applications, including self improvement, that a user may choose as a goal of behavioral modification to be supported by the invention. Among the possible applications are areas such as athletic skills training (for example, prior to a round of golf), stress management, weight loss, smoking cessation, improved concentration, reducing addiction, higher exercise performance, spiritual meditation, professional sleep therapy, and business training for sales, sales motivation and product applications. In some of these applications (such as for stress management) there is the opportunity to use the invention concomitantly with massage therapy. The invention may also be used in health applications that include treatment of insomnia, mental disease (such as depression, anxiety and various addictions), pre-surgical training to familiarize the patient with his pending surgery and post-operative training to ensure compliance with the beneficial therapeutic regime.

Mass personalization of media may be used to enhance their impact to a consumer. Each consumer would be able to customize a message in the manner that best suited them. For example, someone who enjoys recorded narratives (“books on tape”) could have the name of a character substituted with their own name throughout the story. The personalization could be carried out on a mass basis for the entire library belonging to a customer and returned to a customer. Alternatively, a central repository may contain a library of pre-processed media. These media would be maintained as template files in a “potential” state where replaceable portions of text are marked or know by various means described below. The technical system to perform the replacement would preferably be automated so that many users could be served efficiently.

In one general view of the present invention, a script may be developed that invokes a preferred theme and that follows a script for a certain activity (such as a workout, self hypnosis session, etc.). The script can be recorded by one or more human actors or may be developed using computer-generated graphics or audio. The consumer may place an order or may purchase the product after indicating the desired viewer's/listener's name or nickname. Other personalization may also be indicated, such as to alter the age or gender of one or more characters, establish new goals, and replace background music. A system may be developed to embed the desired personalization into the scripted message such that the message appears to be individually directed to the listener/viewer. The message may then be delivered on media or electronically.

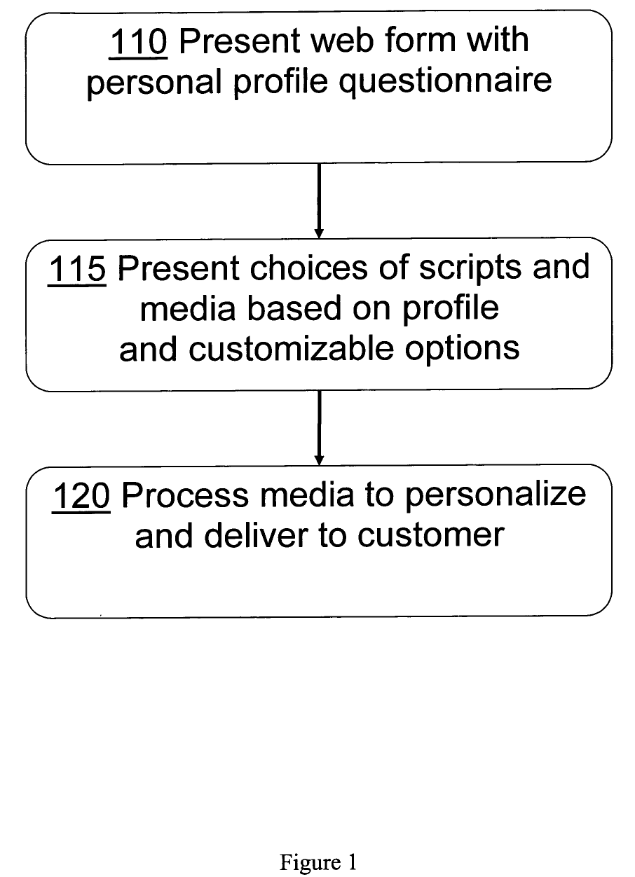

The scripts offered to the customer would be narrowed by their response to profile information, such as a personal questionnaire presented on a web site. Scripts considered attractive to a teenager seeking moderate weight loss of 10 to 15 lbs would differ from those offered an older adult seeking significant weight loss (up to 100 lbs) or to stop smoking. In a preferred embodiment shown in FIG. 1, the invention presents a web questionnaire form 110 with name, age, gender, goal or application (e.g. weight loss) and preferences in music.

A subsequent form could seek further information based on the initial responses, such as educational level and self-assessment of personality type and challenge or difficulty of achieving a desired goal. Next, the current choices of scripts would be presented 115 along with customizable portions. Where pronunciation is significant the customer could select a “play” button on their screen to confirm the vocalization. The selection web page may also allow the customer to enter the name of a script that is not in the pre-recorded library. This would trigger a note estimating the time and extra cost of generating the new script. At the next stage, the customer is presented choices of delivery format and continuity to related scripts. Once the script is ordered, the media is processed 120 to personalize it and then it is delivered to the customer.

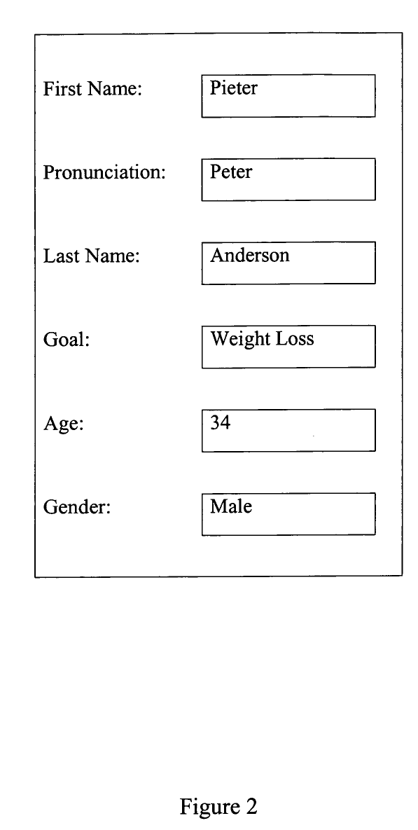

A sample questionnaire is shown in FIG. 2. In that questionnaire, fields are a combination of free text (such as name) and list choices (such as goal). For extremely long lists (such as choosing the name pronunciation) there could be pop-up windows or subordinate lists presented.

After personalization of one or more media programs the system and method will deploy the revised media through streaming or recorded form or other means among a wide range of delivery options known in the art. Examples include mailing the customer a CD or DVD, loading the program directly on to a customer-owned presentation device (such as an MP3 player or laptop computer) or via a transfer device (such as a non-volatile memory “flash drive”) at a kiosk located in a retail store or health club, or by real-time streaming over the internet or dedicated connection.

In addition to content personalization, various themes may be expressed by altering technical or stylistic properties of the media (to a sound file, analog recording or one of several types of multi-media) according to a user's desire. For example, the file format, pace, tone, pitch, speech compression, environment (such as artificial echo or presence), type of message delivery, maximum file size and other features may be pre-selected or altered at any time by the user. Certain themes can be more appropriate for the goal and/or content selected by the user. The invention may provide to the user a set of the most appropriate themes from which the user may choose one or more to be applied to a media program. The user indicates the chosen theme or themes via an interface such as web site.

Overall, the system preferably includes a user interface, extensible set of selections, processing algorithms, database, processing criteria and choice levels. The method encompasses arranging one or more libraries of media, linking the media to one or more databases, offering a customer or customer agent a variable and hierarchical set of choices to personalize the library through the database, implementing the desired alterations and enabling the customer to experience the altered media.

| Key | Title | Author | Class | Length | Source | Type | Copy |
|---|---|---|---|---|---|---|---|
| 1 | Christmas in Camelot | Mary Pope Osborne | LIT | 743 | LOC | AUDIO | © |
| 2 | Christmas in Camelot | Mary Pope Osborne | LIT | 1011 | LIB | TEXT | PUB |
| 3 | Allergies | Stuart Young | MED | 337 | OWN | TEXT | © |

The above table illustrates one configuration of database table used to indicate media selections. In this table, the key index is a unique code for each entry in the table. The title and author of the work are included. Co-authors, publisher and other information could be included in this table or another table linked through the key value. The class of material (e.g. literature, medical reference, military, etc) is included. The length is provided in a manner appropriate to the media (as indicated by Type): pages or word count for printed works, minutes for recordings. Source indicates where repository for the media, such as a local database for a service implementing the present invention, a publicly available electronic library or in the customer's personal library. Copyright information is included.

In a first embodiment, the system and method of this invention replaces one or more names in an original media with the name of the customer or other name chosen by the customer. The customer would first select a template media file or narrative stored as text. The name selected by the customer would be substituted for that of an existing character in the original and then the program would be presented as an audio narrative or other form as desired by the customer. For example, in the tale of “Camelot” all references to Arthur, King Arthur or Arthur Pendragon would be replaced, respectively, with Jim, King James or James Wiltshire. Nicknames, diminutive or pejorative names could optionally be left as in the original.

A second way to accomplish insertion of the listener's name is to predetermine a set of names and have an actor record these names for ultimate insertion into a program. Again using the example of an audio program the original narrator or character voice could record names or sentences containing the names for later insertion in place of original character name. It is likely that the names to be offered to a customer would be selected from among those of greatest frequency, perhaps depending on the age group, residence and language of likely customers.

A third way to accomplish insertion of a customer name is by purchase order from the customer for a script to be recorded and to then add a specific name to the audio script as indicated on the purchase order. The requested program would then be prepared as ordered (e.g. recorded into narrative) and provided to the customer. Because of manual steps or special processing this embodiment of the invention would be less likely to be practiced at point of purchase.

Those familiar with the art will readily understand that replacement is not limited to a character name for the customer but also encompasses other characters, places, identifiable objects, etc. The invention would apply also for selection and/or replacement of phrases and complete sentences. Substitutions could also be made to aid in understanding or for language localization. Further, stories or narratives could be mixed or otherwise rearranged at the same time as name substitution is performed.

It will be understood that the terms “user”, “customer”, “listener”, and “patient” as used herein all refer to the “recipient” as the person who will listen to, read, watch or otherwise experience the personalized media program provided to them by the present invention.

The mass personalization of messages can be used with motivational, educational, meditative or entertainment-oriented recordings to increase the mental, emotional, or physical engagement of the listener with the topic of the message, thereby increasing the desired impact of the message. When modification of behavior or emotion is desired by or for a use the inserted phrases (including names and other examples described herein) will be chosen to provide the most significant and appropriate action.

In one embodiment, a listener's name is inserted numerous times into an audio recording designed to facilitate optimal aerobic exercise sessions. The recording may feature background music which is choreographed to synchronize with the warm up, peak output and cool down portions of an aerobic workout session. The verbal track of the recording may feature one of several themes or fantasies. The themes of a recording might be “football coach”, “army drill instructor”, “personal trainer”, etc. Insertion of the listener's name allows the theme to be personalized to the listener, allowing them to mentally and emotionally engage in the theme and thereby more actively engage in his or her aerobic workout.

In another embodiment of the invention, the listener's name or other substituted text is used in audio recordings designed to increase performance in athletic endeavors. These may not necessarily be private presentations. And the substituted text may be chosen by an agent for the listener, such as a coach. The impact of the audio coaching may be increased due to use of the listener's name.

In a third embodiment, the listener's name is used in audio recordings with educational content. The use of the listener's name increases the mental engagement of the listener and subsequently increases the retention of the material being studied. This technique can be used with educational material used for corporate training or for materials used in traditional kindergarten through college settings.

In yet another embodiment of the invention, the listener's name is inserted into entertainment recordings, thereby personalizing these recordings. For instance, a love song recorded by a professional musician may be mass personalized.

Also, the sound tracks of popular video games can be personalized so that each competitor is made to feel more a part of the action via numerous uses of the listener's name in each competitive session. A further enhancement would alter the selected media replacement as a reward or driver of performance level. Alternatively, the audio qualities could be altered by processing to increase, for example, the level of implied stress and enhance the game experience. For multiple play and similarly interactive games the leading players choice of content is used, such as names with higher perceived status for the leading players and their allies.

In another embodiment of the invention, replaced media is used in audio recordings featuring self-hypnosis or meditative content directed at smoking cessation, weight loss efforts or other goals. The purpose would be to create or reinforce a particular mood or attitude. The use of the specialized replaced audio, such as a listener's name, may increase the impact of the self hypnosis. Directed meditation is one application particularly suited to this invention. A user engaging in directed meditation will listen to an audio recording containing, for example, instructions to close their eyes, breath slowly, and imagine benign circumstance such as a meadow, having lunch, walking on the beach or watching butterflies. This may be accompanied by appropriate sounds or music in the background. By using the present invention the listener will be able to choose each of these and related elements, such as the imagery and music, as well as inserting the listener's name.

In a further embodiment the audio or replaced media can be altered or chosen based on an indication of the customer's performance or condition, either statically or as a goal-based endeavor. An example of this approach would be related to bio-feedback. A physiologic parameter such as HR, respiration, work output or blood pressure could be used to modify the presented media in a way as to influence mood (such as calming when BP rises) or increase performance. During exercise the choice of media or characteristic of the presentation could be altered to influence the listener to a pre-determined level of performance and to induce the listener to maintain or decrease their exertions once the desired level is achieved.

While many of the above embodiments are directed to audio messages, other forms of media may also be mass personalized. For example, DVD or streaming video may be produced such that the viewer's name or other personal characteristic is used in the video. A workout video may use the theme of a football coach and the visual and audio elements of the video may be personalized with the viewer's favorite professional sports team.

As one skilled in the art will readily understand, there are many ways of mass personalizing messages to enhance impact without departing from the scope of the invention. One skilled in the art will also understand that there are many other types of messages and types of mediums that can be used within the scope of the present invention.

In an example embodiment beyond the substitution of names, this invention may replace objectionable or confusing text or text phrases with more suitable substitutes. For example, a set of expletives are each replaced with corresponding approved terms prepared by a customer or related group. Words describing sexual acts or intentions solely for their expletive effect (not as narrative descriptions of sexual acts) would be replaced with words analogous in impact, but avoiding sexual reference. Application of this technique could be employed to alter a rating assigned to the media based on textual content, similar to ratings of PG, R, X, etc assigned to films by the Motion Picture Association of America (MPAA).

Alternatively, text and phrase substitution could be employed to replace relatively benign words with words having more “bite” in an effort to increase interest or to update a work. These might be works originally created to achieve a particular rating or at a time when social restrictions limited the use of even current vernacular. Similarly, replacements might be able to adapt a fairy tale to a more “adult” audience.

Obsolete words, little known or outdated slang could be substituted to aid understanding where comprehension is more important than the artistry of the original phrasing. The listener (such as the child of a customer) could subsequently or previously listen to or experience an original version.

Similarly, vocabulary could be simplified by replacing specific jargon with more common and descriptive phrases. These phrases could be obtained from a glossary provided in the print version of a book when the book content is presented as an audio recording. Information contained in glossaries, appendices and codicils are generally ignored in audio—this system and method would provide a means for such information to be included. And the information would be presented in a fashion controlled or influenced by the customer. In this case it may be less necessary to achieve verisimilitude in the media presentation as the customer would be more interested in comprehension.

Sets of replacement texts could be prepared by a third party individual or group and presented to the customer. A set prepared by a customer could be deployed to recognize place names, types of flora or fauna (such as those more familiar, or less familiar and more exotic) and dialectual or educational level preferences. Substitutions could be made in the first instances in an extended form (see Text2 samples in the table below) and later in a shortened form (Short or Text1 in the table below), or in the original form as the material progresses.

| Key | Text1 | Text2 | Short | Class | Glossary |
|---|---|---|---|---|---|
| 1 | EPIDERMIS | TOP LAYER | SKIN | MED | 231 |
| | | OF SKIN | | | |
| 2 | GI | GASTRO- | STOMACH | MED | 352 |
| | | INTESTINAL | | | |
| 3 | GI | GASTRO- | INTESTINE | MED | 512 |
| | | INTESTINAL | | | |
| 4 | GI | USA ENLISTED | SOLDIER | MIL | 134 |
| | | SOLDIER | | | |

Replacements may also be drawn from a master table, a partial example of which is presented in the table above. Here the table contains a “Field” describing the art or topic area of the term. Original media would be identified for field so that the appropriate replaceable text could be identified when there is a homonym or ambiguity. These measures would aid understanding at the choice of the customer beyond that provided by the original author.

When a pre-defined set of replacements is employed it may be desirable to vary the replacement of expletives or other content randomly, by character or in another way that helps to prevent boredom and that disguises when replacement has occurred. This may be especially useful when the number of substitutes is limited (e.g. less than the range of original portions to be replaced) or when substitutes are likely to carry less impact than the original text.

In one embodiment of the invention, audio messages are personalized via the insertion of the customized text into the script of an audio message. In one form this is created as a text-to-speech application. The listener's name and/or other short pieces of text are substituted for identified text in a base script. The spoken recording is created by computer synthesis of a human voice or by sound concatenation with post processing. These are among techniques known in the art for automatically approximating human speech. Text-to-speech has the advantage of complete customization and avoids discontinuities in sound patterns when an original recording is modified.

A custom or customized script may be read or acted as a recording for delivery to a customer. The recording may be prepared by one or more actors, by a practitioner such as the customer's physician or trainer, by the customer or by a customer's agent. The recorded media would preferably be prepared in a manner that facilitates later insertion or replacement of portions of the recording. Exemplary means of facilitating modification of the recording include identifying readily replaceable sections (e.g. character names where appropriate or complete sentences when insertion of a name alone would disrupt continuity) by inaudible marks or timings. An extensible set of replacement segments would then be recorded by the same actors or other person as the original recording, stored in a database, and mixed in a manner well known in the art to prepare each customized recording.

For both the live recording and text-to-speech approaches the recording can be created as a single, continuous narrative. However, greater benefit may be derived from organizing the script and recording as sections that can be rearranged, dropped or added as necessary. The rearrangeable sections can provide a variety of customization options. For example, sections or script elements can be classified as initiation, maintenance and recovery. When applied to an exercise session these sections or segments can be arranged and concatenated to accommodate lengthened or higher level exercise periods as a customer's physical condition improved. To give a more specific example, a customer might be served initially by one initiation segment of 2 minutes, 2 maintenance segments of 4 minutes each and a recovery (or cool-down) segment of 3 minutes for a total session of 13 minutes. The next week the number of maintenance segments could be doubled, raising the duration of exercise to 21 minutes. In addition, rearrangeable sections smaller than an entire segment (such as a sentence, paragraph or thematic element) could be altered between consecutive maintenance segments to provide variety with the intent of keeping the interest and focus of the listener.

For pre-recorded audio, the replaceable portions can be recognized from the text by a listener who creates embedded marks or who enters timings in a database table. Once a representative substitution portion or text is located in the medium, such as an audio recording, it can be analyzed for spectral characteristics (as either the time or frequency functions) of that portion and then matched at other locations by scanning algorithm. A pattern match or correlation function can be used for the scan. Or else the replaceable portion can be converted to a different representation such as a wavelet or Fourier transform array. One representative technique recognized in the art is voice stress analysis. The replaceable portions can be identified with these techniques either completely automatically, or used as aids to enable a listener to more rapidly scan the recorded media.

Where the text of pre-recorded media is available it can be analyzed first by text-to-speech software to estimate the locations by timing of text to be replaced. These timings can be stored in a table and used as aids for a secondary step of automatic or manual processing of the media to identify each replaceable portions. By combining two replacement techniques the assurance level of making all desired replacements increases.

When aiding a technician to locate the replaceable sections in a piece of media an algorithm would be used to partially pre-identify the text and then check manually. Techniques of this sort are adapted from applications such as translation assistance software. In this fashion candidate text can be scored for approximate certainty by such means as an embedded numeric value or color code.

The insertion of the listener's name could be accomplished in several different ways using various technologies known in the art. One way the insertion could be accomplished would be to develop computer generated voice replication capability such that the listener's name is inserted into a voice script in such a way that it sounds like the same voice as the actor's voice who is speaking the main body of the audio script.

Replacement could be managed in a configuration similar to hypertext. As illustrated in Example #1, the marks “fn” inside the <> symbol pair show where the given name should be inserted. Similar codes can indicate insertion of a place name, nickname or a surname alone or in combination with the given name. Additional marks can indicate modifications in pronunciation, as shown in example #2 where the mark “em” means the contained word should be sounded with emphasis. Example #2 also shows how replacements are not limited to a single replacement text.

Emphasis, such as that in Example #2, could be obtained by a number of means. For example, it could be one of several “readings” of a text stored in a database and be selected when the “em” code is encountered. In this method there would exist a separate table in the relational database that further contained cross substitutions for the “em” code if that reading is not available or if the “em” reading is closest to a missing reading corresponding to a different code. Alternatively, the pitch, tone, frequency, speed or other spectral characteristic of the reading could be altered and stored in the database or created in “real-time”. The means of altering the reading would, in one preferred embodiment, be stored in yet another table of the relational database. More advanced means of producing the correct reading are also encompassed by the method of this invention and include summarizing a spectral pattern from just before and after the inserted reading (linked to a particular speaker or character if dialog) and applying it (such as by truncated convolution with the time-frequency spectrum) to the reading. Alternatively, the applied spectral alteration could come from a static set of spectra derived from analysis of different readings for short sections of text.

Example of text configuration #1: “It was a dark and stormy night when <fn> George </fn> realized that he needed motivation during exercise”.

Example #2: “<fn><em> George </em></fn> look out, the tree is about to fall!” Shouted <fn2> Mary</fn2>.

Example #3 of replaceable section: “<nm>It was <tm>four o'clock in the morning</tm> when <fn>George</fn> <ln>Dupont</ln> closed the door and came down the steps to the street.</nm> The first faint streaks of dawn were in the sky, and <ppn>he</ppn> noticed this with annoyance, because <ppn>he</ppn> knew that <pp>his</pp> hair was in disarray and <pp>his</pp> whole aspect disorderly; yet <ppn>he</ppn> dared not take a cab, because <ppn>he</ppn> feared to attract attention at home. When <ppn>he</ppn> reached the sidewalk, <ppn>he</ppn> glanced about <op>him</op> to make sure that no one had seen <pnp>him</pnp> leave the house, then started down the street, <op>his</op> eyes upon the sidewalk <op>before him</op>.”

An alternative embodiment to marking only replaceable sections in an original text is to decompose the entire text of a given media. Each proper name, sentence or phrase would be marked as described above. The sections would then be recombined as required to produce the complete program in a fashion that incorporates all the substitutions requested by the customer.

Example #3 shows several aspects of replaceable sections. The first sentence contains the complete character name and is marked with <nm>. Separate sentences could be recorded and stored in a database and used to replace the original first sentence while incorporating a different character name. If the new character is female then the various personal pronouns in the subsequent sentences would need to be modified. This could be achieved, in this example, by replacing just the marked pronouns or by recording a feminine version of each sentence. The <op> symbols demark words or phrases that may be omitted without changing the meaning of the script but do serve to simplify replacements (in this case by omitting two pronouns). Alternatively, the entire script may be re-written to preserve the meaning and style of the original while minimizing the number of names, pronouns, etc that must be replaced. Additionally, the <tm> delineates a time that can be altered at the choice of a customer (keeping in mind that the subsequent sentence refers to dawn). Example #4 shows the text in Example #3 after the character is changed to a female, “Alice Smith”, changes are made to the time, and optional segments are removed.

Example #4 replaced version of Example #3: “<nm>It was <tm>five thirty in the morning</tm> when <fn>Alice</fn> <ln>Smith</ln> closed the door and came down the steps to the street.</nm> The first faint streaks of dawn were in the sky, and <ppn>she</ppn> noticed this with annoyance, because <ppn> she </ppn> knew that <pp>her</pp> hair was in disarray and <pp> her </pp> whole aspect disorderly; yet <ppn>she</ppn> dared not take a cab, because <ppn> she </ppn> feared to attract attention at home. When <ppn>she </ppn> reached the sidewalk, <ppn> she </ppn> glanced about to make sure that no one had seen <pnp> her </pnp> leave the house, then started down the street, eyes upon the sidewalk.”

Pre-recording of names, especially given names, should be prepared in a structure such as a relational database. The table below exemplifies the organization in such a database for storing replacement text. The fields in each record of the database should preferably include such additional pre-recorded information as nicknames, variant pronunciation and differences resulting from emotion. The database tables should contain links to related names to speed customer searches or to serve as substitutes.

| Key | Name | Nickname | Alternate | Key Referent | Variant |
|---|---|---|---|---|---|
| 1 | JAMES | JIM | JAIMES | 232 | |
| 2 | JOHN | JACK | JON | 353 | |
| 34 | STEPHEN | STEVE | STEVAN | 513 | Follow S |

The key index for the above table is based on name frequency (which is unique). The alternate field contains homonym text. The key referent helps to lead a customer to similar names, aiding the search. Sibilant indicates text that may interact in variant fashion with the indicated ending preceding the inserted text.

It may be undesirable to attempt to create database entries for all possible replaceable names. For surnames the first 17900 in the 1990 census are required to reach the 50^{th} percentile in the cumulative distribution. Given names for females reach the 50^{th} percentile at 138 names and at 60 names for males. The number of given names more than doubles to reach the 75^{th} percentile: approximately 524 for females and 233 for males. Therefore, it may be reasonable to pre-record given names by an actor that can be selected by a customer. However, pre-recording surnames may not be efficient and preparing combinations of given and surnames would require substantial resources.

Because spoken phrases are sometimes contiguous with a name or other word that is desired to be replaced it may be desirable to prepare a database of pre-recorded phrases that may be substituted into a recorded script read by the same actor. For example, this generic phrase library could contain such recordings as: “Thank you John.”; “Thank you Jim.”; “Thank you Alice.”; or “I'm glad Joan could join us today.”; and “I'm glad Jim could join us today.”. A further example could be time of day: “It was five thirty in the morning.”; “It was five o'clock in the morning.”; “It was noon.”. Though these time phrase examples are scripted with a period, they could be used in Examples #3 and 4 to replace the time text marked by <tm> tags because the pronounced sound of the period would be the same as the comma in the original.

To match intonation for the original text the located sections of replaceable text could be compared to a neutral or other reference sample. A cross-correlation of the spectrum of each replaceable section against the reference sample would be applied to the substitute text to impose the approximate intonation.

Distribution of the media could be as a transportable file created at the point of purchase. The customer could choose from a set of replaceable text (character or place names, etc) and enter their original text or choose again from a table of available elements. Prepared elements could include the most common given and surnames. Prepared elements can be linked in a relational database to necessary variants (tense, inflection) and could be a characterized spectral structure. Elements chosen from set would be encoded as sound or phoneme. Freely entered elements would have to be created as text-to-speech if not found in a table.

If the media is ordered for later delivery the arbitrary element could be created by audio recording (by an artist) or more sophisticated computer processing not available at the point of sale. The substituted portion could also be recorded by the customer or someone acting on behalf of a customer (as a gift from friend or relative, or trainer/physician), sent to a service implemented the present invention and returned to the customer in completed form.

Actual transport of media to the customer is familiar in the art, as stated above, and includes computer compatible systems such as streaming, recording to flash or magnetic storage device (MP3 player or similar), and permanent recordable media (CD or DVD).

In another preferred embodiment, all operations could be carried out on a customer's computer and media equipment or other processing system. The necessary database and algorithm-driven replacement software could also be provided to a customer with “hooks” and an application interface that accesses the customer's local library of media and performs substitutions such as those described above.

An example of this system embodiment would be a company that purchased a system to regularly personalize messages to its sales organization. The messages could be and customized for name and data specific to each recipient. For example a message from a sales executive to the company's 1500 sales people could review their sales performance in the past year. The message to the top quintile of sales performers would read in part: “<fn>Jim</fn> the entire management team and shareholders at Pan Am thank you for your outstanding record of exceeding your target by <sale%>30</sale%> percent.” The executive would have pre-recorded the first and last names of all the sales personnel and the readings of a variety of numerals into a database. A similar message to the lowest quintile of sales performers to read, in part: “<fn>George</fn> thank you for your contributions to Pan Am in the past year. I'm sure you realize that your performance was <sale%>30</sale%> percent below target and negatively impacted our overall performance.” A third message would be similarly prepared for the middle 3 quintiles to cover the entire sales force. The message could be distributed by mass internal voice mail techniques already known in the art.

The system and method of this invention may include coaching or motivational techniques that significantly impact health. Therefore, means must be provided to accommodate prescription by a physician. For example, the prescription could implement a series of increased length or intensity in the narrative. Additionally, the prescription would describe the frequency of the session provided with the media (e.g. daily) and the duration until the next physician visit or subsequent program (e.g. 30 days).

The system and method of the present invention must properly manage copyright. Various configuration can be provided such that, for example, a customer uploads media they have already purchased to a website where the replacements are performed and the customer can subsequently download or retrieve the altered material. Significant alterations may require creation of new copyright assigned to the customer. Means for propagated copyright on external materials would be provided by tracking copyright status in a database (see the ‘media selections’ table discussed above) and ensuring that original and altered copyright materials are transmitted only to the owner or licensee. Approved methods for managing copyright are known to those skilled in the art and are available from various services in a form compatible to the practice of this invention.

The foregoing description addresses embodiments encompassing the principles of the present invention. The embodiments may be changed, modified and/or implemented using various types of arrangements. Those skilled in the art will readily recognize various modifications and changes that may be made to the invention without strictly following the exemplary embodiments and applications illustrated and described herein, and without departing from the scope of the invention, which is set forth in the following claims.

What is claimed is:

1. A method for personalizing media to enhance a user's receptiveness to the media, the method comprising:
receiving user information;
selecting a template media file for personalization based on the user information;
creating a personalized media program for the user by altering the template media file based on the user information; and
delivering the personalized media program to the user.

2. The method from claim 1, wherein the user information is received from an electronic questionnaire.

3. The method from claim 1, wherein the user information includes a user goal.

4. The method from claim 3, further comprising receiving the user goal from a medical professional having a relationship with the user.

5. The method from claim 1, further comprising receiving a program theme indicator for indicating thematic content to be personalized in the media program during the step of creating.

6. The method of claim 1, further comprising presenting a set of recommended themes, wherein the set is a function of the user information.

7. The method from claim 6, wherein the set of themes is generated from a user goal to enhance the effectiveness of the program to aid the user in achieving the goal.

8. The method from claim 1, further comprising: selecting a first plurality of phrases containing a name of the user from a database of prepared phrases; and
inserting the selected phrases in pre-designated portions of the template media file when creating the personalized media program.

9. The method from claim 8, wherein the selected plurality of text phrases includes variations on a name of the user.

10. The method from claim 8, further comprising:
presenting one or more of the selected phrases to the user; and
allowing the user to select a second plurality of phrases when the first plurality of phrases are unsatisfactory.

11. The method from claim 1, further comprising:
selecting, from a database of behaviorally significant phrases, a plurality of phrases that aid modification of user behavior to achieve the user goal; and
inserting the selected phrases in pre-designated portions of the template media file.

12. The method from claim 1, wherein the step of creating comprises an actor recording the template media file.

13. The method from claim 1, further comprising altering qualities of the personalized media program based on the user information.

14. The method from claim 13, wherein the pacing of the personalized media program is changed.

15. The method from claim 1, wherein background audio is added to the personalized media program.

16. The method from claim 1, wherein the personalized media program is delivered to the user electronically.

17. The method from claim 1, wherein the personalized media program is intended to support behavior modification; and
wherein the user goal is a behavioral goal.

18. The method from claim 17, wherein the behavioral goal is one of: weight loss, smoking cessation, calming, improved concentration, reducing addiction, higher exercise performance or falling asleep.

19. The method from claim 17, wherein the user information comprises the perceived difficulty of achieving the behavioral goal.

20. A computer program embodied on a computer readable medium, the computer program executable by a computer for personalizing media, the computer program comprising:
a code segment for receiving user information;
a code segment for selecting a template media file for personalization based on the user information;
a code segment for creating a personalized media program for the user by altering the template media file based on the user information; and
a code segment for delivering the personalized media program to the user.

21. A system for personalizing media, comprising:
means for receiving user information;
means for selecting a template media file for personalization based on the user information; means for creating a personalized media program for the user by altering the template media file based on the user information; and means for delivering the personalized media program to the user.

22. A system for personalizing media, comprising: a receiver for receiving user information; a selector unit for selecting a template media file for personalization based on the user information; a creation unit for creating a personalized media program for the user by altering the template media file based on the user information; and a delivery unit for delivering the personalized media program to the user.
